(19) United States
(12) Patent Application Publication
(10) Pub. No.: US 2022/0064938 A1
(43) Pub. Date: Mar. 3, 2022

(54) Low Cost and Emergency Housing

(71) Applicant: VBBT Corp, Hartford, CT (US)

(72) Inventors: Yuk-Kwan Brian Yuen, Wethersfield, CT (US); Venesia Hurtubise, Fort Myers, FL (US); William John Kehoe, Hartford, CT (US); Thomas J. Kennedy, III, Harwich, MA (US)

(73) Assignee: VBBT Corp, Hartford, CT (US)

(21) Appl. No.: 17/522,685

(22) Filed: Nov. 9, 2021

Related U.S. Application Data
(63) Continuation-in-part of application No. 16/571,068, filed on Sep. 14, 2019, now Pat. No. 11,168,485.
(60) Provisional application No. 62/731,865, filed on Sep. 15, 2018.

(51) Int. Cl. E04B 1/76; E04H 1/12; E04C 2/24; B32B 7/12; B32B 3/12; B32B 27/06; B32B 5/02

(52) U.S. Cl. CPC E04B 1/7604; E04H 1/1205; E04C 2/243; B32B 7/12; E04B 2001/742; B32B 27/06; B32B 5/02; E04H 2001/1283; B32B 3/12

(57) ABSTRACT

A construction material structure, comprising a plurality of inner support columns, the support columns being fixtured at the top end portion and/or the bottom end portion in a generally parallel, spaced apart arrangement, a polymeric film stretched across a first side and an opposite second side of the support columns, a quick cure polymeric fibrous material formed on the outer surface of the stretched polymeric film, and a polymeric foam disposed between the support columns and the stretched polymeric film.

### CROSS-REFERENCE TO RELATED APPLICATIONS

This application is a continuation-in-part of co-pending U.S. application Ser. No. 16/571,068 filed Sep. 14, 2019, which claims the benefit of U.S. Provisional Application No. 62/731,865 filed on Sep. 15, 2018, the contents of these earlier applications being incorporated by reference herein in their entirety.

### BACKGROUND

A housing crisis exists worldwide where the need for low cost and easily transported and placed housing has become critical. Also, climate change has caused more destructive storms which have increased the need for emergency housing. There is therefore a need for easily deployable, low cost housing solutions that are logistically superior to the current housing deployment solutions and that do not impact the environment once their use is terminated.

Current housing solutions, including the reuse of shipping containers, have several disadvantages. These include the following: 1. The cost of the units where the build out of the units can push the cost close to $100,000, 2. Logistics where transportation and site location can cause significant challenges, 3. The aftermath of disaster relief efforts where the residual, used housing can cause a significant environmental issue, 4. The absence of sustainable and renewable material in the build out of the housing solutions, 5. The lack of standardized intercommunicability of the housing units as well as service interfaces such as water, electrical and electronic, and 6. The absence of build-in-place systems.

Therefore, a new low cost and easily deployable housing solution is desired to both alleviate the housing crisis and to offer improved aid in disaster relief efforts.

### SUMMARY

The present disclosure relates, in various embodiments, to new technologies that are available for low cost and disaster relief housing.

One aspect of the new technology is comprised of the ability to fold shipping containers flat for shipping and then restoring the units to a 3D configuration through the use of smart folding technology, utilizing elastomeric joints and hardened connectors. This configuration allows greatly improved and rapid deployment of the housing solutions. Elastomeric joints may be thermoplastic or thermoset such as thermoplastic polyurethanes or cross-linked cis-poly isoprene rubber. The hardened connectors may be case hardened steels, composite connectors or other types of viable materials that would be utilized in a connector or pinion or bolt.

A further embodiment is the use of renewable and sustainable materials for the build out of the shipping containers and, eventually, production of the containers themselves. Materials may include the use of high amylose starch based wall boards and sucrose based polyurethane foam for insulation, sound proofing, structural integrity and aesthetics.

The starch based wall boards are composed of a high amylose starch which may also be mixed gypsum and other fillers. The wallboards are coated with high molecular weight polyvinyl alcohol coatings and acrylic coating combinations which protect the wall boards while in use but may be scored after the useful life of the material has been reached to accelerate natural decomposition and composting of the wallboards.

One of the great aspects of shipping containers is the ability to stack the containers. This aspect of the shipping containers, however, is not needed for a single level housing solution. Structural integrity may be maintained by a combination of metal stringers and sucrose based polyurethane foam injected into the interstitial spaces to tie the system together. The frames of existing shipping containers may be utilized but the system also lends itself to a primary construction production.

The sucrose based polyurethane foam may be blown with gas, such as pentane, but may also be blown with water where the water reacts with the polyisocyanate to form polyurea and carbon dioxide that is encased in the foam as it is blown up to 20 times its volume. The polyurethane foam may also have fire retardant materials such as sodium borate (borax), aluminum trihydrate and other fire resistant materials.

Sandwich construction may also be utilized to manufacture components of the low cost and disaster relief housing solutions. For sandwich construction, typically there is a stiff outer layer, many times known as the face sheet, that is adhered to both sides of a honeycomb or foamed or low density interior portion where the adhesion is accomplished by a thin layer of adhesive or glue. The adhesion may also be achieved by having like materials adhere to each other such as a styrene modified polyester resin adhering to a styrene containing foam. The sandwich construction here may be composed of renewable, recyclable, or biodegradable materials. For instance, interior honeycomb or foam may be a starch based material that will degrade upon exposure to enzymatic processes, sunlight, moisture, and the like.

One embodiment described herein is a system comprising a framework and a plurality of structural components, wherein the combination of the framework and the structural components form a part of a housing construction, wherein the framework is comprised of in-service or out-of-service shipping containers, and wherein the structural components are comprised of renewable and sustainable materials and are recyclable or compostable. In embodiments, the structural materials comprise at least one of starch integrated wall board and sucrose based polyurethane foam. In some cases, the structural materials comprise at least one of lignin-based polyurethane resins and lignin-based polyurethane foams. In embodiments, the framework comprises metal stringers and foam-in-place material.

A further embodiment is a system comprising a framework and a plurality of structural components, wherein the combination of the framework and the structural components form a part of a housing construction. The framework is comprised of shipping containers, and at least a portion of the structural components are formed from compostable materials. In embodiments, the structural materials comprise at least one of starch integrated wall board and sucrose based polyurethane foam. In some cases, the structural materials comprise at least one of lignin-based polyurethane resins and lignin-based polyurethane foams. In embodiments, the framework comprises metal stringers and foam-in-place material.

Another embodiment is a system comprising a light weight core material and a facing material formed on the light weight core material, wherein the facing material comprises a filamentous woven or non-woven material and a polymeric resin material, and the polymeric resin material is infused into the filamentous woven or non-woven material. In embodiments, the system comprises a framework and a plurality of structural components, wherein the combination of the framework and the structural components form a part of a housing construction, wherein the framework is comprised of in-service or out-of-service shipping containers, and wherein at least a portion of the structural components comprise compostable material.

Yet another embodiment is a method of making the system described in the previous paragraph.

A further embodiment is a method of forming a sandwich construction wherein the exterior faces are formed first and the interior lightweight material is formed in situ between the exterior faces to form a continuous structure, wherein the interior lightweight material imparts strength to the sandwich construction.

Another embodiment is a product made by the method described in the preceding paragraph. A further embodiment is a foldable housing construction comprising one or more of the systems described above.

A further embodiment is a construction material structure comprising a plurality of inner support columns, the support columns being fixtured at the top end portion and/or the bottom end portion so as to be in a generally parallel, spaced apart arrangement, a polymeric film stretched across a first side and an opposite second side of the support columns, a quick cure polymeric fibrous material formed on the outer surface of the stretched polymeric film, and a polymeric foam disposed between the support columns and the stretched polymeric film. The quick cure polymeric fibrous material comprises at least one of an unsaturated polyester and a UV-cured polymer.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates a conventional high end shipping container-based home.

FIG. 2 is an illustration of a conventional shipping container before any modification.

FIG. 3 is stick figure description of the polyurethane reaction.

FIG. 4 shows the configuration of a sucrose polyol that can be utilized to make polyurethane foam used in embodiments described herein.

FIG. 5 shows the process of polyurethane foam being applied to an interior wall.

FIG. 6 is a picture of a metal studded wall configuration.

FIG. 7 illustrates the degradation cycles for poly lactic acid.

FIG. 8 is a depiction of sandwich construction for embodiments described herein.

FIG. 9 is a picture of a folding shipping container.

FIG. 10 it is a picture of the federal emergency management agency trailers utilized after hurricane Katrina.

FIG. 11 is an exploded view of a shipping container converted to emergency housing with biodegradable build out components.

FIG. 12 shows a building with walls and a roof formed from panel constructions described herein.

FIG. 13 depicts a multi-layer construction of a panel in accordance with certain embodiments.

FIG. 14 shows details of the panel illustrated in FIG. 13.

FIG. 15 is a partially broken away view of a wall in accordance with the embodiment shown in FIG. 12.

### DETAILED DESCRIPTION

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

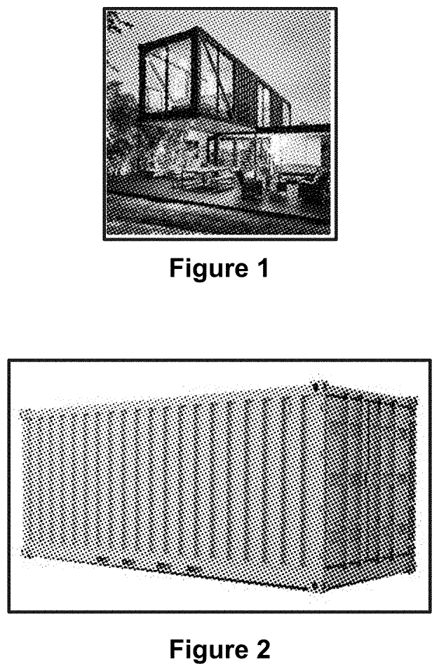

The home that is illustrated in FIG. 1 is a conventional high-end, high-priced shipping container home. While this is a novel use of decommissioned or new shipping containers, it is the aim of the embodiments described herein to produce low-cost and easily deployable disaster relief housing, some of which will incorporate shipping containers.

FIG. 2 shows on unadulterated conventional shipping container. The structural integrity of these rectangular boxes is such that they may be stacked six high when shipping. However, the structural integrity is not necessarily a need in low-cost and disaster relief housing.

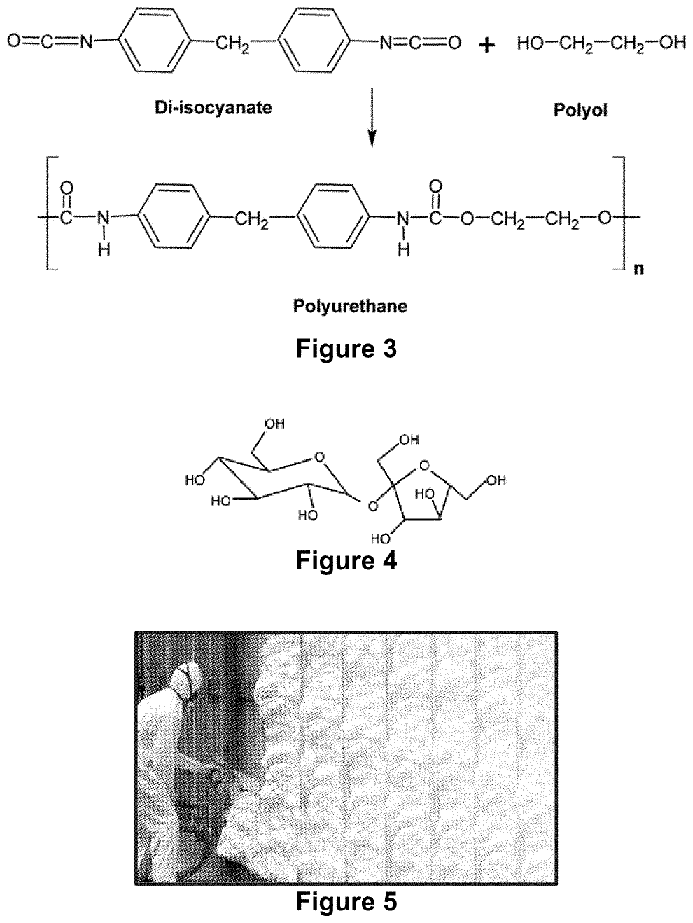

FIG. 3 is a schematic of the polyurethane reaction, utilizing a polyol and an isocyanate to produce the polyurethane. The focus on the polyol portion of the equation is important from the aspect of renewable materials may be utilized to make these hydroxyl functional polyols. These include sucrose based polyols and concern based polyols. It may also include lignin based polyols.

FIG. 4 shows the sucrose polyols that may be substituted into the polyurethane schematic to react with polyisocyanate and form polyurethane. Sucrose is a renewable resource and many sugar operations have other waste streams that may be utilized as a reactive material with polyisocyanates to form polyurethanes.

FIG. 5 is a picture of the application process for polyurethane foam into a wood studded wall. Here, the polyurethane may add structural integrity to the wall such that it can be cam a loadbearing component of the low cost or disaster relief housing.

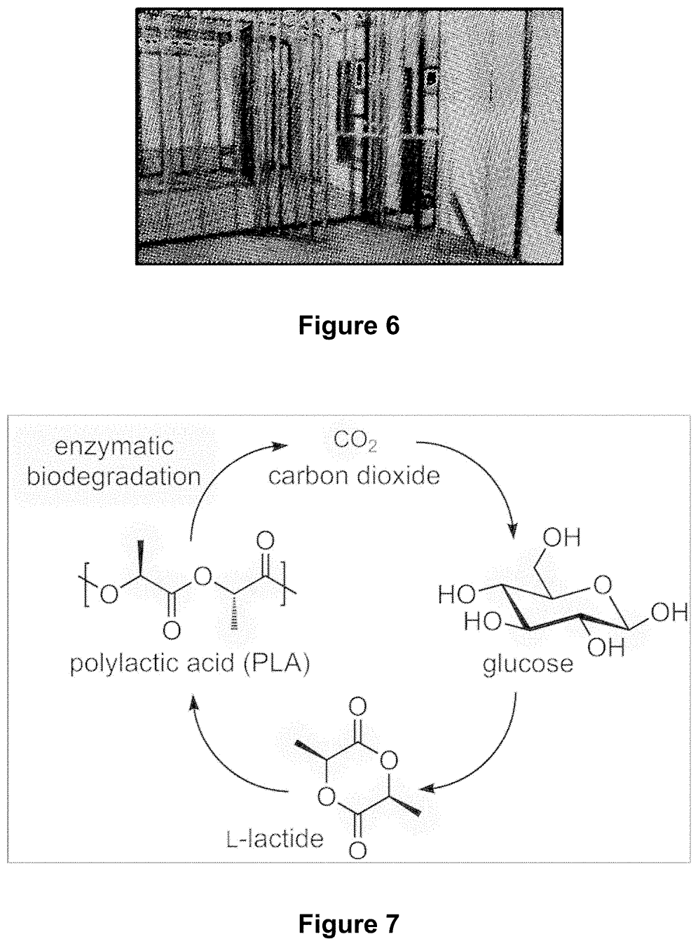

FIG. 6 is a picture of a metal studded construction where wood has been eliminated and semi-structural metal pieces have been put in place.

FIG. 7 shows the degradation cycle of poly lactic acid. Poly lactic acid (PLA) is being utilized more and more in consumer applications where recyclable and renewable processes have not necessarily taken hold and this is an attempt to improve the bio degradation of used plastic.

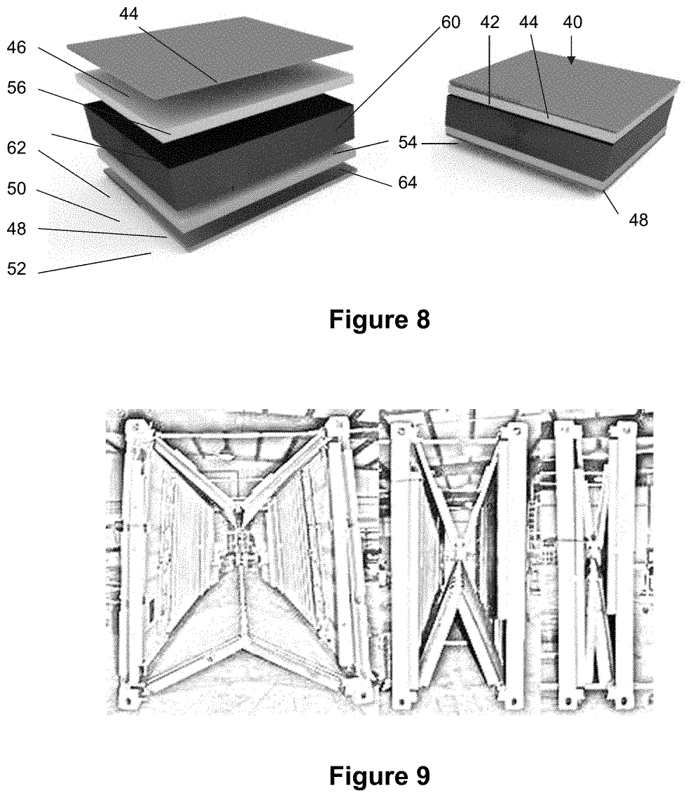

FIG. 8 shows an example of the sandwich construction that may be utilized in building out the low cost housing or disaster relief housing. Sandwich construction offers a very high strength in one direction. It may also be utilized to build materials that will biodegrade quicker once the exterior of the component is disrupted or scored or cut.

FIG. 9 is a pictorial of a folding shipping container. This allows for improved logistics and deployment of the shipping container.

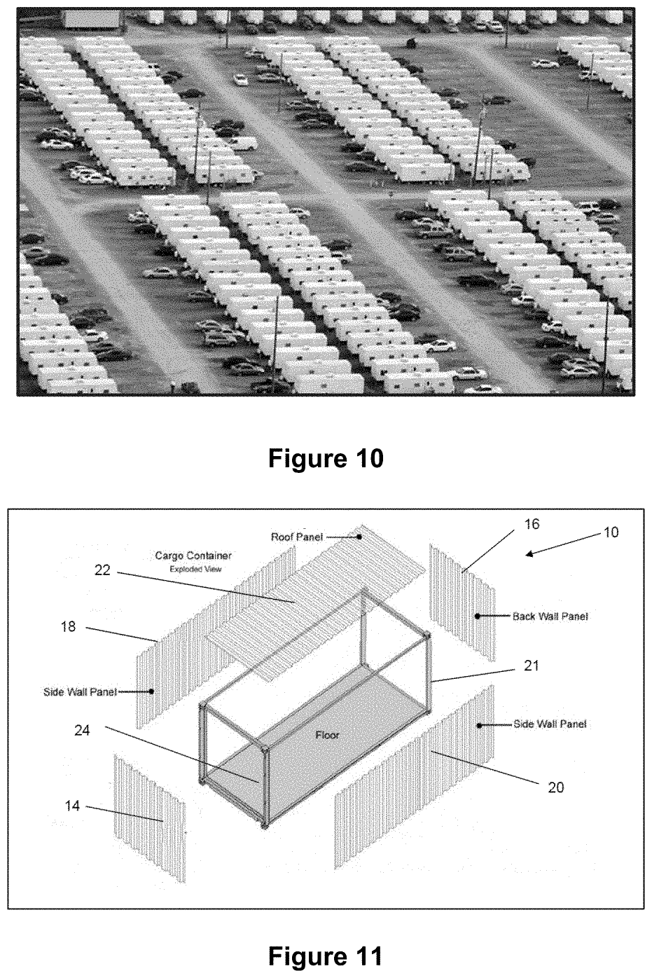

FIG. 10 shows multiple mobile housing units deployed by the federal emergency management agency (FEMA). One of the issues with deployment of emergency housing is in the aftermath of the emergency need or disaster. The housing or shelter units are typically in very poor condition and there is a need for a massive cleanup of the compromised units. As an answer to this problem, a housing or shelter unit that is easily deployed and easily disposed of when no longer needed is a real need especially in the emergency management arena. Another embodiment of this application is a shipping container shell that contains biodegradable buildout materials such as wallboards and furniture. When the need for the emergency and/or disaster shelter or housing is over, the biodegradable interior of the housing unit or shelter may be removed and composted while the external shell of the housing or shelter unit may be crushed. In some embodiments, the entire unit is made of recyclable or biodegradable materials such as reinforced poly lactic acid, starch based building materials and other recyclable, compostable, or renewable materials.

FIG. 11 is an exploded view of a converted shipping container 10 for emergency housing. The exterior components, including an exterior front wall 14, an exterior back wall 16, an exterior first side wall 18, an exterior second side wall 20 that usually is parallel to the first side wall 18, the roof 22 and the floor 24 may be made of structural material such as corrugated steel, aluminum and other recyclable metals. The interior components are formed from compostable and recyclable materials such as poly lactic acid and polyethylene terephthalate, respectively.

In embodiments, one or more of the exterior front wall 14, exterior back wall 16, exterior first side wall 18, exterior second side wall 20, the roof 22 and the floor 24 are made of compostable materials. In these embodiments, a key material is the coating that is on the exterior of the future compostable materials. Environmentally durable coatings such as polyurethanes, specifically polyether and polyester polyurethanes, provide durability, abrasion resistance and self-healing capabilities. Once these coatings are stripped off, the interior components of the structural pieces will be exposed to the environment and thus break down to microbial, UV, hydrolysis, and other environmental factors that will allow degradation of the materials to gases and small molecules. Non-limiting examples of methods to strip off the exterior coatings include scoring the surface of the polymer or otherwise degrading the film integrity so as to allow degradation of the interior components of the composite and start the bio degradation process. The exterior material may also be stripped off with high temperature water or a solvent such as acetone.

The sandwich panel shown in FIG. 8 is generally designed as 40. This panel includes a first face sheet 42 with an exterior side 44 and an interior side 46, a second face sheet 48 with an interior side 50 and an exterior side 52, and a core 54 positioned between the first face sheet 42 and the second face sheet 48. In embodiments, a first adhesive layer 56 connects the first face sheet 42 to a first side 60 of the core 54. In embodiments, a second adhesive layer 62 connects the second face sheet 48 to a second side 64 of the core 54. FIG. 8 shows a core 54 formed from a honeycomb material, however, the sandwich panel alternatively or additionally may utilize other materials as the center, filler portion in place of, or in addition to, the honeycomb material. These materials include balsa wood which is a lightweight cellular wood with good strength characteristics. Balsa wood also has excellent shear properties so that the exterior faces of the sandwich construction remain stable with shear forces placed on the structure. The balsa wood core may be a solid monolithic core or it may be divided into different geometric sections so as to conform to the molding process of the exterior faces on the sandwich construction.

The polymeric resin used on the facing material for the sandwich construction may be of various types provided it is biodegradable, similar to the exterior coatings. One type that may be utilized is a soybean derived epoxy system. In embodiments, the epoxy is cured with an amide or amine curative. In some cases, the chemical makeup of the epoxide system is such that it will lend itself to biodegradation with the application of heat, pressure, humidity, and combinations of other environmental factors.

In embodiments, the composite material for the facing materials comprises a natural fiber. Non-limiting examples of suitable natural fibers include sisal, hemp, bamboo, jute, and cotton. In embodiments, the natural fibers are saturated with the soy-based epoxy system and applied to the exterior faces of the balsa or foam core and allowed to cure. This forms a sandwich composite construction that has an excellent combination of mechanical strength, shear resistance, and biodegradation capabilities.

Fastening areas or components may be built into the composite sandwich construction components such that secondary beams, specialty fasteners, and other joining techniques may be utilized to join various composite components to each other. These fastening areas may be as simple as a surface extension on the sandwich construction panels that will accept a crossbeam and thus strengthen the sandwich construction panel and or join it to another sandwich construction panel.

Interfaces between the composite panels may be accomplished through various specialized joints such as a U joint or an H joint. These joints may be made out of thermoplastic or thermoset materials such as thermoset rubber or thermoplastic polyurethane.

In some cases, the interior components of the housing are configured to begin to decompose when exposed to high humidity conditions and/or water that is at standard temperature and pressure or elevated temperature. The exterior coating materials, such as polyvinyl alcohol films, may be modified such that various times for biodegradation may be built into the composite. For instance, a low molecular weight polyvinyl alcohol films will allow faster degradation than will a high molecular weight polyvinyl alcohol film. Copolymers, such as polyvinyl acetate, may also be added to the exterior films, such as polyvinyl alcohol, to change the degradation attributes of the materials.

The various components of the sandwich construction may be tied together with an adhesive, such as a pressure sensitive adhesive that is either thermoplastic or thermoset. In other cases, mechanical fasteners are used in place or, or in addition to the adhesive.

The sandwich construction may also be utilized to make various components of furniture for the low cost emergency housing structures. The various components of the furniture may be incorporated into the structural configuration for the low cost emergency housing. For instance, the seat of a couch made from sandwich construction may be utilized to make part of a wall while the legs of a chair may be utilized as beams to strengthen components of the low cost emergency housing. Fasteners and adhesives may be utilized to incorporate the furniture components into the structural components of the low cost emergency housing.

The advent of 3D printing houses has brought new technology to the area of the fast production of housing. The means for accomplishing this 3D printing process, however, is expensive and has a high impact on the environment. In most cases, the 3D printing material is a cementitious mixture. Cementitious mixtures account for approximately 5% or more of carbon dioxide emissions, a larger percentage than the entire airline industry.

An improved method of producing low cost housing in a short time frame may consist of a hybrid model of 3D printing techniques and robotic material processing.

Polyols for polyurethane foams the produced from carbon dioxide feedstocks. This allows for a net negative greenhouse gas emission process. These polyurethanes may be utilized for building materials.

These polyurethane foams produced from carbon dioxide feedstocks may be utilized to fill a structure that is comprised of support columns, such as steel slats, paper rolls, or a plastic lattice with a skin of plastic film and an outer skin of a quick cure fibrous matte. A 3D type gantry system may be utilized to introduce the polyurethane foam into a hollow wall structure. Robotic techniques may be utilized for the foam introduction as well.

The support columns are fixtured to an upper support beam and a lower support beam. The support columns have spaces therebetween allowing for the introduction of foam in between adjacent support columns. A plastic film, such as polyurethane or cellulose acetate is stretched across the support columns to form a thin wall on the support columns.

A quick cure mixture of a polymeric material and a fibrous material is coated, sprayed, or adhered onto the outside of the stretched film. The polymeric fibrous layer is allowed to cure and harden.

The polymeric material in the polymeric fibrous layer may be a UV curing material.

A foam in place material, such as a carbon dioxide based polyurethane foam, is utilized to fill the inner spaces between the support columns and interior to the plastic film and the quick cure polymeric material.

The construction is thus a polymeric fibrous outer layer that is applied onto a plastic film that is stretched tightly across the fixtured support columns with the space between the support columns being subsequently filled with a foam in place material.

The quick cure polymeric fibrous outer layer may be an unsaturated polyester polymer that is modified with a reactive diluent such as styrene and with a curing catalyst such as MEK peroxide. The material may be sprayed onto the stretched plastic film with a chopper gun that chops a fibrous material, such as fiberglass, while spraying a quick cure material.

The quick cure polymeric fibrous outer layer may also utilize a UV curing material as the polymeric component.

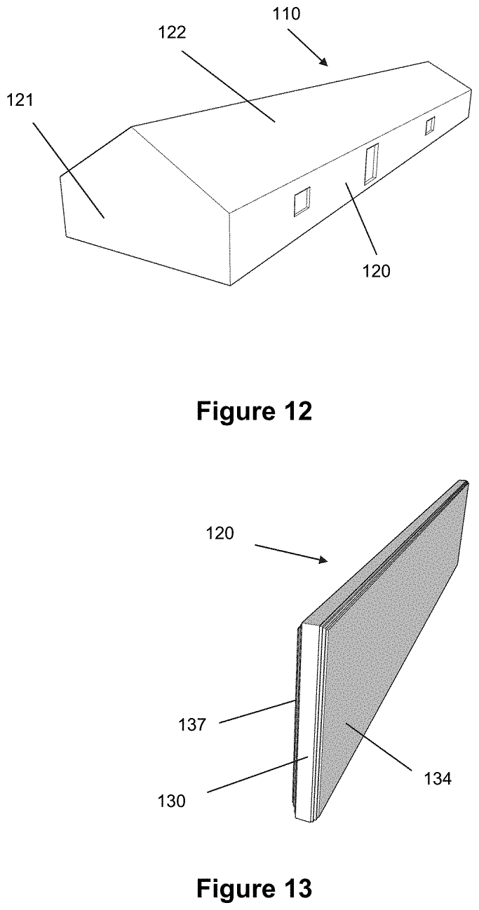

FIG. 12 shows the multilayer construction of the building material. In this embodiment, the side walls 120, end walls 121 and roof 122 of a building 110 are formed from panels of the construction material structure. It is also noted that one or more of the wall and roof panels of the structure shown in FIG. 11 can be formed with this construction.

FIG. 13 is a depiction of the multilayer finished construction of an exterior wall or other building panel 120 for a house or building with an inner exterior layer 137 of a fibrous polymeric material, an outer exterior layer 134 of a fibrous polymeric material, a film layer directly interior to each of the exterior layers 137 and 134, interior support columns (hidden within the inner foam material), and an inner foam layer 130 formed from a foam material. This configuration can be used to form a wall or ceiling of a house or other building. The layers 134 and 137 are functional layers and can be covered with an aesthetically pleasing layer, as is discussed below.

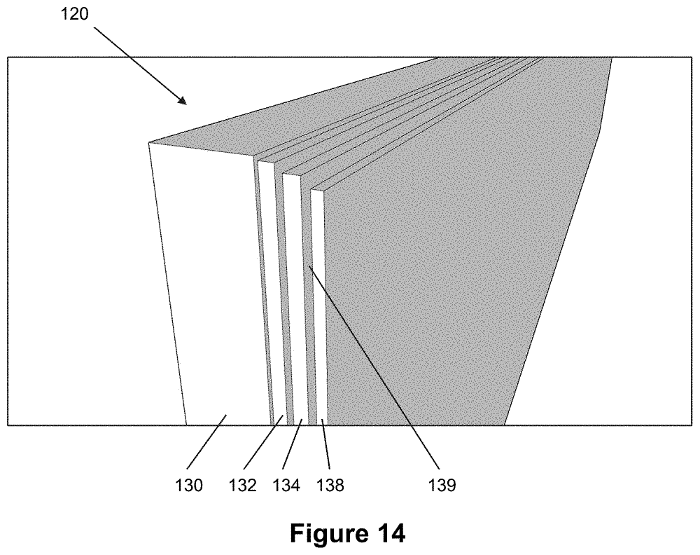

FIG. 14 is a schematic close-up of the multilayer material showing the layers visible from the outer side of the panel 120. The inner foam layer 130 is adjacent to a stretched film layer 132. A polymeric fibrous layer 134 is formed on the stretched film layer 132. The outer surface of layer 134 is designated as 139. A finish panel 138 of an architecturally pleasing outer layer, made of a material such as wood, thermoplastic, thermoset, or metal, including but not limited to aluminum, is attached to layer 134 with a mechanical fastener or an adhesive.

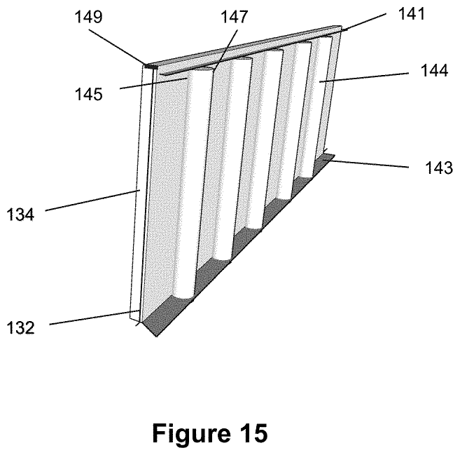

FIG. 15 is a depiction of the inner support columns 144 with an outer exterior film layer 132 stretched tightly on one side and a polymeric fibrous layer 134 formed on the film layer 132 before foam is inserted. This figure is partially broken away to show the arrangement of the columns in accordance with one embodiment, and the thicknesses of the layers are exaggerated for illustrative purposes. The support columns 144 are fixtured to an upper support beam 141 and a lower support beam.143. Each column has a first side 145 and an opposite second side 147. The full construction will have a film stretched tightly on both sides of the support columns, and a polymeric fibrous layer exterior or the film layer. A fastener 149 is configured to correct the illustrated structure to another wall or ceiling structure.

In some cases, the columns are mounted vertically before the film layer is stretched on the front and back sides. The foam is then added. In other cases, wall structures are pre-formed, transported to an installation site, and then mounted to form a building.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

1. A system comprising:
a framework and a plurality of structural components, wherein the combination of the framework and the structural components form a part of a housing construction,
wherein the framework is comprised of in-service or out-of-service shipping containers, and
wherein the structural components are comprised of renewable and sustainable materials and are recyclable or compostable.

2. The system of claim 1 wherein the structural materials comprise at least one of lignin-based polyurethane resins and lignin-based polyurethane foams.

3. The system of claim 1 where the framework comprises metal stringers and foam-in-place material.

4. A construction material structure, comprising:
a plurality of inner support columns, the support columns being fixtured at the top end portion and/or the bottom end portion in a generally parallel, spaced apart arrangement,
a polymeric film stretched across a first side and an opposite second side of the support columns,
a quick cure polymeric fibrous material formed on the outer surface of the stretched polymeric film, and
a polymeric foam disposed between the support columns and the stretched polymeric film.

5. The construction material structure of claim 4, wherein the plurality of inner support columns are fixtured on both the top end portion and the bottom end portion.

6. The construction material structure of claim 4, wherein the plurality of inner support columns are fixtured using first and second support beams.

7. The construction material structure of claim 4, wherein the polymeric fibrous material is cured after being applied to the outer surface of the stretched polymeric film.

8. The construction material structure of claim 4 wherein the quick cure polymeric fibrous material comprises at least one of an unsaturated polyester and a UV-cured polymer.

9. The construction material structure of claim 4, further including at least one secondary structure formed on at least one of an interior surface and an exterior surface of the construction material structure to accommodate a fastener.

10. The construction material structure of claim 4 wherein the polymeric foam comprises a combination of a polyol and an isocyanate forming a polyurethane foam.

11. The construction material structure of claim 4 fastened to additional construction material structures forming a plurality of walls of a building.

12. The construction material structure of claim 11, wherein the building is a house.

13. A method of forming a sandwich construction wherein the exterior faces are formed first and an interior lightweight material is formed in situ between the exterior faces to form a continuous structure, wherein the interior lightweight material imparts strength to the sandwich construction.

14. The method of claim 13, wherein the lightweight material comprises a foam.
